(19) United States
(12) Patent Application Publication
(10) Pub. No.: US 2012/0001049 A1
(43) Pub. Date: Jan. 5, 2012

(54) LATCH MECHANISM

(75) Inventors: Kurt A. Selbold, Whitmore Lake, MI (US); Karl G. Sponsler, Canton, MI (US); Michael J. Thomas, Ann Arbor, MI (US)

(73) Assignee: JOHNSON CONTROLS TECHNOLOGY COMPANY, HOLLAND, MI (US)

(21) Appl. No.: 12/305,262

(22) PCT Filed: Jun. 10, 2008
(86) PCT No.: PCT/US08/66437

§ 371 Date: Sep. 30, 2010

Related U.S. Application Data
(60) Provisional application No. 61/046,135, filed on Apr. 18, 2008.

(51) Int. Cl. B60N 2/075; B60N 2/08

(52) U.S. Cl. 248/429; 403/83

(57) ABSTRACT

A latch 30 for use in a track assembly 16 for adjusting the position of a vehicle seat 10 has a one-piece construction and operates non-linearly an X-Y plane within a space 20 defined by the first and second track members 17 and 19 of the track assembly 16. A blocker member 44 limits the latch member 31 from disengaging the first and second track members 17 and 19 and includes an optimized latch and track engagement construction and a separate blocker member 44 for optimizing engagement of the latch 30 and track member 17 and moveable for allowing disengagement of the latch 30. The track assembly 16 containing a part includes an actuator 34 for operating the latch 30 and the actuator 34 includes a connector 32 for pivotally connecting the actuator 34 to the track assembly 16 and for connecting the latch 30 to one of the first and second track members 17 and 19.

### CROSS-REFERENCE TO RELATED PATENT APPLICATIONS

The present claims priority under 35 U.S.C. §119 to U.S. Provisional Application No. 60/934,097, filed Jun. 11, 2007, in the name of Balin and titled “Vehicle Seat Track and Latch Assembly” and U.S. Provisional Application No. 61/046,135, filed Apr. 18, 2008, in the name of Balin et al. and titled “Latch Mechanism” the disclosures of which are incorporated herein by reference in their entirety.

### BACKGROUND

The present disclosure relates generally to latches for use in adjustable devices. More particularly the present disclosure relates to a latch mechanism for use in an adjustable track mechanism in a vehicle seat.

It is generally known to use a latch mechanism for locking relative movement between a first member and a second member. It is generally known to use a latch mechanism and an actuator device in an adjustable track assembly for adjusting the fore—aft position of a vehicle seat in a vehicle. Such a track assembly is known for use in a providing fore-aft adjustment to vehicle seat such as a “captain's chair” or other type of vehicle seats. The linear adjustable vehicle seat allows an occupant to obtain a more comfortable seating position and to provide space behind or in front of the vehicle seat. Generally, latch mechanisms are known for latching the vehicle seat position at a plurality of locations. Such latch mechanisms are generally known as pawl and positive engagement latch-type devices and mechanisms. Examples of generally known latch mechanisms include those disclosed in documents U.S. Pat. No. 5,275,370; U.S. Pat. No. 4,568,054; U.S. Pat. No. 5,524,504; U.S. Pat. No. 5,918,847; U.S. Pat. No. 5,772,173; EP 0098702; GB 2,286,522; DE 4242895; EP 0683066; U.S. Pat. No. 5,806,825; U.S. Pat. No. 6,036,267; EP 0765777 and DE 10 2004 051 694 A1.

There remains a continuing need to provide an improved and simplified latch mechanism that provides greater design options while providing similar and/or greater performance than compared to generally known designs.

### SUMMARY

The present disclosure relates generally to a latch for use in coupling a first member to a second member. In one exemplary embodiment, a latch for latching a first track member and a second track member, wherein the second track member is movable relative to the first track member in at least one degree of freedom, includes a latch body having a first portion for attaching the latch to one of the first and second track members and a second portion extending from the first portion; a third portion connected to the second portion and having an engagement portion (which may optionally be a plurality of teeth) for transferring loads between the first and second track members to prevent relative movement there between; a fourth portion connected to the second and third portions, the fourth portion for connecting to an actuator for actuating the latch. In the one exemplary embodiment, the fourth portion contacts the track member to prevent the engagement portion from disengaging from the first and second track members when a load is applied to one of the first and second track members. In one particular exemplary embodiment, the latch is manufactured as a one-piece construction. In one particular exemplary embodiment, the latch is manufactured from a single-piece of material using stamping and folding operations.

In one exemplary embodiment, a latch for latching a first member and a second member, wherein the second member is movable relative to the first member in at least one degree of freedom, includes a latch body having a first portion for attaching the latch to one of the first and second members and a second portion extending from the first portion; a third portion connected to the second portion and having an engagement portion (which may optionally be a plurality of teeth) for transferring loads between the first and second members to prevent relative movement there between; a fourth portion connected to the second and third portions, the fourth portion for connecting to an actuator for actuating the latch; and a pivot member for forming a connection among the actuator, the second member and the latch such that the first portion of the latch is fixedly connected to the second member and the pivot member is pivotally connected to the second member.

In one exemplary embodiment, a latch for latching a first member and a second member, wherein the second member is movable relative to the first member in at least one degree of freedom, includes a latch body having a first portion for attaching the latch to one of the first and second members and a second portion extending from the first portion; a third portion connected to the second portion and having an engagement portion (which may optionally be a plurality of teeth) for transferring loads between the first and second members to prevent relative movement there between; a fourth portion connected to the second and third portions, the fourth portion for connecting to an actuator for actuating the latch; and a blocker member having a first portion connected to the second member, a body portion of the blocker member extending from the first portion; and an end portion extending at least partially into the hole in the second member and aligned proximal the fourth portion of the latch to engage the fourth portion when a load is applied to the second member. In one particular exemplary embodiment, the actuator engages the blocker to move the blocker from a hole in the second member. In one particular exemplary embodiment the actuator moves the blocker simultaneously while the actuator moves the latch toward the unlatched position.

In one exemplary embodiment, a latch for latching a first member and a second member, wherein the second member is movable relative to the first member in at least one degree of freedom along a longitudinal axis and including a plane extending horizontally to the longitudinal direction of the first and second members, the latch including a connection portion for connecting the latch to one of the first and second members; a body portion extending from the connection portion; and a latch portion connected to the body portion, the connection portion and the body portion for biasing the latch portion in a second direction in the horizontal plane and not aligned with the longitudinal direction, the latch portion for latching the first and second track members to transfer a load applied to one of the first and second track members to the other of the first and second track members, wherein the latch portion is movable in the horizontal plane to latch the first and second track members. In one particular exemplary embodiment, the latch is manufactured as a one-piece construction. In one particular exemplary embodiment, the latch is manufactured from a single-piece of material using stamping and folding operations.

### BRIEF DESCRIPTION OF THE DRAWINGS

The foregoing and other features of the exemplary embodiments will become more apparent to one skilled in the art upon consideration of the following detailed description and the accompanying drawings in which:

FIG. 1 is a perspective view of a vehicle including a vehicle seat having a latch mechanism according to an exemplary embodiment.

FIG. 2 is a perspective view of vehicle seat of the vehicle of FIG. 1.

FIG. 3 is a perspective view of the vehicle seat of FIG. 2 with the trim cover and the foam cushions removed showing the vehicle seat structures.

FIG. 4 is a side view of a seat base and track assembly of the vehicle seat of FIG. 3.

FIG. 5 is a perspective view of the seat base and track assembly of FIG. 4.

FIG. 6 is a perspective, exploded view of a pair of track members, a latch mechanism with a blocker and an actuator and pivot connection according to one exemplary embodiment.

FIG. 7 is a partial, perspective view of an actuator and a pair of adjustable track members including a latch mechanism with a blocker in a latched (unactuated) position according to one exemplary embodiment and aligned with an X, Y, Z coordinate system where the X direction coincides with the longitudinal direction of the track members.

FIG. 8 is not included.

FIG. 9 is a partial, section view of the latch mechanism and track members of the exemplary embodiment of FIGS. 7 and 8.

FIG. 9A is a perspective, exploded view of a pair of track members, a latch mechanism without a blocker and an actuator and pivot connection according to one exemplary embodiment.

FIG. 10 is a partial, perspective view of an actuator and a pair of adjustable track members including a latch mechanism with a blocker in an unlatched (actuated) position of the exemplary embodiment.

FIG. 11 is a partial, perspective elevation view of the actuator and pair of adjustable track members of FIG. 10 showing the latch mechanism with a blocker in the unlatched (actuated) position of the exemplary embodiment.

FIG. 12 is a partial, section view of the latch mechanism with a blocker and track members of the exemplary embodiment of FIGS. 10 and 11.

FIG. 13 is a perspective view of a blacker member of the latch mechanism of the exemplary embodiment of FIGS. 6 through 9A and FIGS. 10 through 12.

FIG. 14 is a top plan view of the blocker member of the latch mechanism FIG. 13.

FIG. 15 is a side plan view of the blocker member of the latch mechanism FIG. 13.

FIG. 16A and FIG. 16B is perspective view of a pair of end pieces of the actuator for engaging the latch mechanism according to the exemplary embodiment.

FIG. 17 is partial, perspective view of the latch member of the latch mechanism including the fasteners for attaching the latch member to the track member according to the exemplary embodiments.

FIG. 18 is a partial, perspective view of an actuator and a pair of adjustable track members including a latch mechanism in a latched (unactuated) position according to one exemplary embodiment.

FIG. 19 is an end planar view of the actuator, the pair of adjustable track members and latch mechanism of FIG. 18 showing the interaction of the engagement piece of the actuator and the latch member and track members according to the exemplary embodiment.

FIG. 20 is a partial, side view of an actuator and a pair of adjustable track members including a latch mechanism in an unlatched (actuated) position according to one exemplary embodiment.

FIG. 21 is an end planar view of the actuator, the pair of adjustable track members and latch mechanism of FIG. 20 showing the interaction of the engagement piece of the actuator and the latch member and track members according to the exemplary embodiment.

FIG. 22 is a partial, perspective view of an actuator and a pair of adjustable track members including a latch mechanism having a blocker member in a latched (unactuated) position according to one exemplary embodiment.

FIG. 23 is an alternate, partial perspective view of the device shown in FIG. 22.

FIG. 24 is a partial, cross-sectional view of the device of FIGS. 22 and 23 showing the latch member and blocker member and connection in the latched (unactuated) position.

FIG. 25 is a partial, perspective view of an actuator, a pair of track members and a latch mechanism in the latched (unactuated) position.

FIG. 26 is a cross-sectional view the pair of track members and the latch mechanism of FIG. 25.

FIG. 27 is a partial, perspective view of the actuator, pair of track members and latch mechanism of FIGS. 25 and 26 moved to the unlatched (actuated) position.

FIG. 28 is a cross-sectional view the pair of track members and the latch mechanism of FIG. 27.

FIG. 29 is a partial, perspective view of the actuator, track members and latch mechanism according to one alternate exemplary embodiment shown in the latched (unactuated) position.

FIG. 30 is an end view of the embodiment of FIG. 29 with the latch mechanism in the latched (unactuated) position.

FIG. 31 is a partial, cross-section view of the pair of track members and the latch mechanism of FIGS. 29 and 30 with the latch mechanism in the latched (unactuated) position.

FIG. 32 is a partial, perspective view of the actuator, track members and latch mechanism of FIGS. 29 through 31 shown in the unlatched (actuated) position.

FIG. 33 is an end view of the embodiment of FIG. 32 with the latch mechanism in the unlatched (actuated) position.

FIG. 34 is a partial, cross-section view of the pair of track members and the latch mechanism of FIGS. 32 and 33 with the latch mechanism in the unlatched (actuated) position.

FIG. 35 is a partial, cross-section view of the pair of track members and the latch mechanism of the exemplary embodiment of FIGS. 25 through 34 with the latch mechanism in the latched (unactuated) position and under a load applied in a first direction A and illustrating the latch mechanism engaging the one track member 17.

FIG. 36 is a partial, cross-section view of the pair of track members and the latch mechanism of the exemplary embodiment of FIGS. 25 through 34 with the latch mechanism in the latched (unactuated) position and under a load applied in a second direction B and illustrating the latch mechanism engaging the one track member 17.

FIG. 37 is a partial cross-section, plan view of the latch mechanism and pair of track members according to the exemplary embodiment of FIGS. 6 through 12 wherein the latch mechanism is in the latched (unactuated) position and under a load applied in a first direction A and illustrating the latch mechanism engaging the blocker member.

FIG. 38 is a partial cross-section, plan view of the latch mechanism and pair of track members according to the exemplary embodiment of FIGS. 6 through 12 wherein the latch mechanism is in the latched (unactuated) position and under a load applied in a second direction B and illustrating the latch mechanism engaging the one track member 17.

FIG. 39 is a pair of end views of a traditional track section and a track section according to an exemplary embodiment illustrating the latch member included in a shorter track section height application.

FIG. 40 is an isometric view of the latch according to another exemplary embodiment.

FIG. 41A is an isometric view of a latch member according to another exemplary embodiment.

FIG. 41B is a cross-section view of a latch member of FIG. 41A taken through one of the rivet portions coupling the latch member to the track.

FIG. 42A is an isometric view of a latch member according to another exemplary embodiment.

FIG. 42B is cross section of the latch member of FIG. 42A taken through one of the tabs coupling the latch member to the track.

FIGS. 43A and 43B are isometric views of the latch member of FIG. 40.

FIGS. 44A and 44C are isometric views of a latch member according to another exemplary embodiment.

FIGS. 44B and 44D are cross-sections of the latch members of FIGS. 44A and 44C taken through the fastening members coupling the latch member to the track.

FIG. 45A is an isometric view of a latch member according to another exemplary embodiment.

FIG. 45B is a cross-section of the latch member of FIG. 45A taken through the fastening members coupling the latch member to the track.

FIG. 46A is an isometric view of a latch member according to another exemplary embodiment.

FIG. 46B is a cross-section of the latch member of FIG. 46A taken through the fastening members coupling the latch member to the track.

FIG. 47A is an isometric view of a latch member according to another exemplary embodiment.

FIG. 47B is a cross-section of the latch member of FIG. 47A taken through the fastening member coupling the latch member to the track.

### DETAILED DESCRIPTION

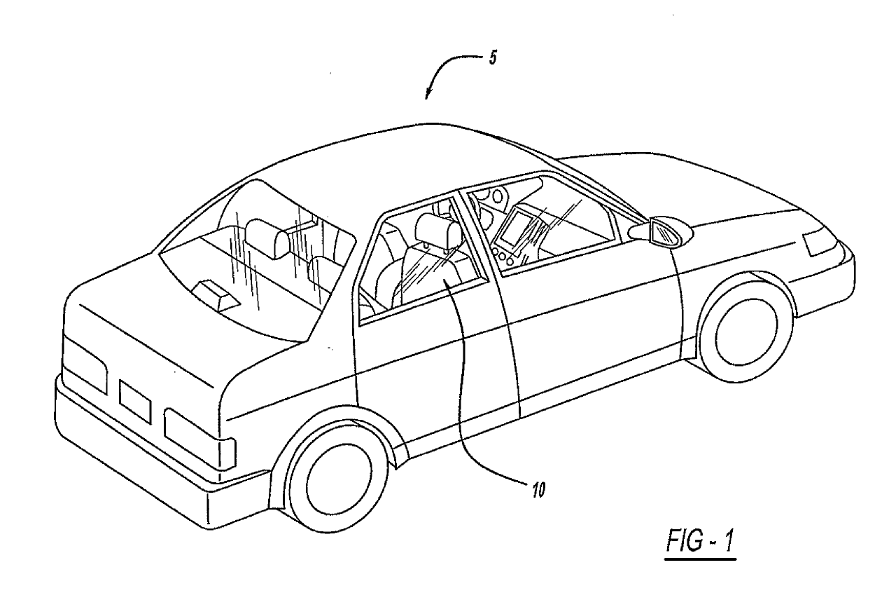

Referring to generally to the FIGURES and in particular to FIGS. 1 through 5, vehicle seat track latch mechanisms are shown according to exemplary embodiments. The latch mechanisms are configured for selectively controlling the position of a vehicle seat relative to the interior of the vehicle. The latch mechanisms and methods described herein may be used in a variety of applications such as seats, including seat systems (e.g., front seats, second or third row seats, bucket seats, bench seats, etc.) such as the vehicle 5 of FIG. 1 or any other known type of automobile, truck, van, SUV, train, airplane, boat, etc. The latch mechanisms are also useful in any non-vehicle seat application wherein it would be desirable to use a latch mechanism to control the latching of two members or elements (e.g., theatre seats, doctors' chairs, adjustable shelving, etc.).

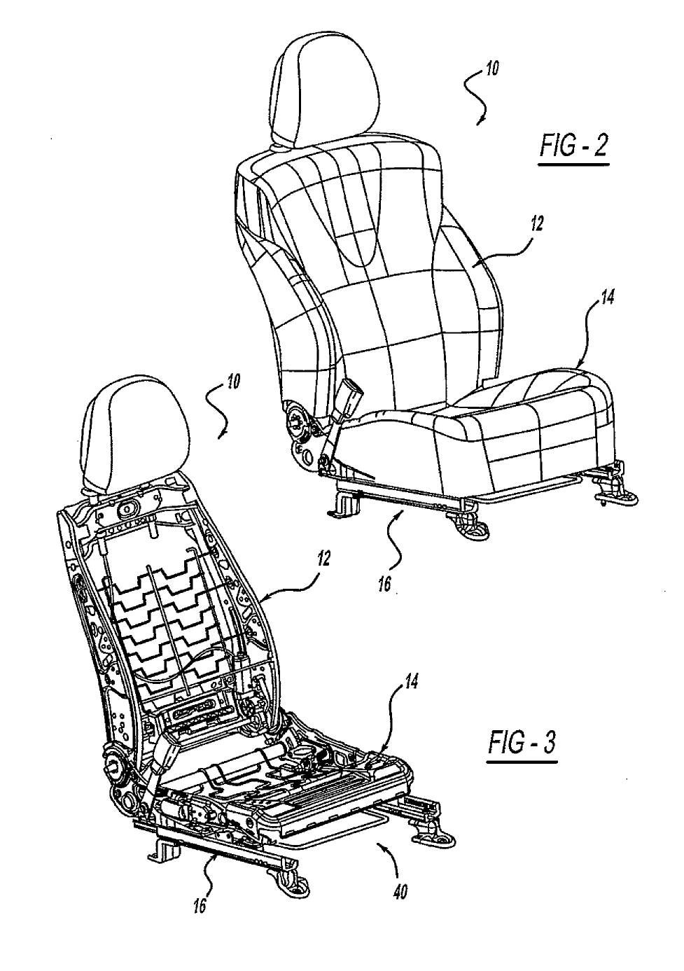

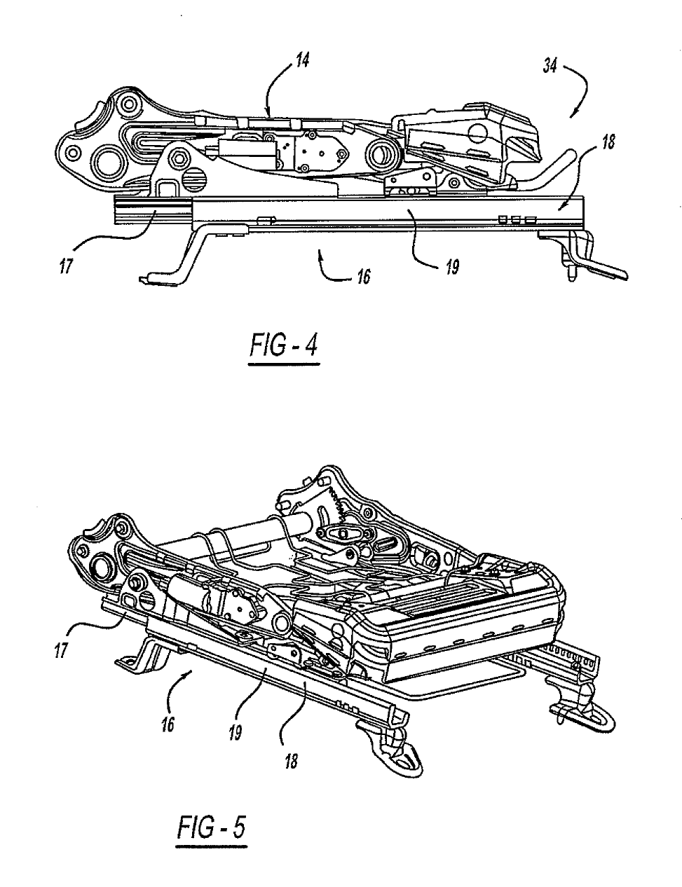

The latch mechanisms of the disclosed exemplary embodiments are particularly useful in a vehicle seat 10, see FIGS. 2 and 3, having a seat back 12, a seat base (or cushion) 14 and a track assembly 16. The latch mechanisms may be used in a variety of applications but are particularly within the track assembly 16, see FIGS. 4 and 5 in particular, for latching the track assembly 16 in a secure position, and unlatching the track assembly 16 for adjusting the position of the vehicle seat 10 within the cabin of the vehicle 5 such as in the fore—aft direction of the vehicle 5.

According to an exemplary embodiment, the track assembly 16 is designed to move the vehicle seat 10 within the vehicle 5 a distance of travel between a full-forward position and a full-rearward position. The track assembly 16 includes an inboard and an outboard pair of track members 18, each of which includes a first (upper or male) track member 17 and a second (lower or female) track member 19. According to the various alternative embodiments, the latch mechanism 30 may be configured to adjust the vehicle seat 10 through any amount of travel based upon the lengths of the seat track members 17 and 19.

The first and second track members 17 and 19 are designed to be coupled for relative movement there between and define a space (or cavity) 20 for housing various components for providing adjustment, latching and other functional features useful in the track assembly 16. A friction reducing device, such as ball bearing races (which are removed from the figures for ease of understanding) are utilized for providing sliding movement of the first track member 17 with respect to the second track member 19 although any known or appropriate type of friction reducing device may be utilized. While it is typical to have two seat track assemblies 18 as part of the track assembly 16 to support the vehicle seat 10, it is understood there may be any number of track assemblies 18 as may be appropriate for a given application.

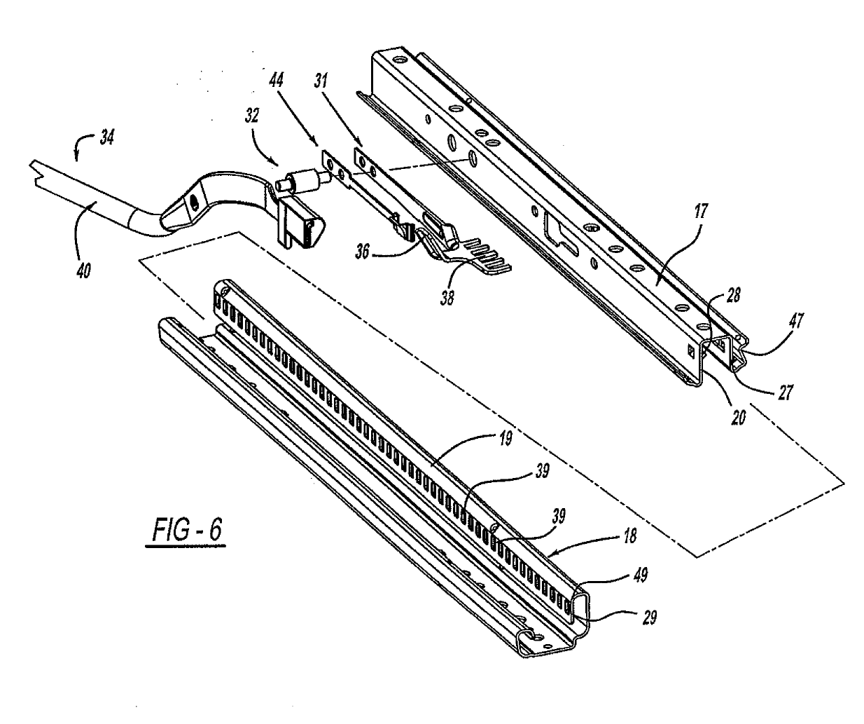

A latch mechanism (or device) 30, as best shown in FIG. 6, is configured for selectively allowing the movement (e.g., translation, rotation, etc.) of the first track member 17 with respect to the second track member 19 between a first position and a second position. The latch mechanism 30 is configured to latch the position of the vehicle seat 10 at various positions (e.g., increments, etc.) along the lengths of the track members 17 and 19. One of the pair of track members 17 and 19 (in particular the second track member 19 as disclosed in FIGS. 2 through 5) is made stationary, such as by coupling, directly or indirectly through a bracket, to the structure (typically the floor) of the vehicle 5.

The first track member 17 includes a first portion arranged as a generally vertically aligned first wall (or portion) 27 having a plurality of holes 37 (or windows, passages, etc.) arranged to be aligned in a generally straight row along a portion of the wall 27 of the track member 17. The first track member 17 further includes a second wall 47 (or portion) having a plurality of holes 57 (or windows, passages, etc.) arranged to correspond to and align with the holes 37 in the first wall 27 of the first track member 17 such that an engagement portion 50 of the latch mechanism 30 may transfer loads between the first and second track members 17 and 19 and prevent relative movement there between. While it is contemplated and disclosed that the upper and lower track members 17 and 19 have an interlocking connection (the end walls of the generally u-shaped track members double back in the interconnection) and the engagement portion 50 passes through the holes (or windows, passages, etc.) 37, 39 and 57 of the track members 17 and 19, it should be understood that the latch mechanism 30 may be used in any variety of track assembly 16 arrangements.

In one exemplary embodiment, the latch mechanism 30 includes a latch member 31 that has a first end or portion 35 coupled to the inside of the first track member 17 within the space 20 but may alternatively be coupled to the second track member 19 or to other structure provided the latch member 31 is operable to latch the one track member 17 to the other track member 19. The one track member 17 to which the latch member 31 is attached may be either one of the male or female (or upper or lower) track members 17 and 19. The one track member 17 has a first surface 27 positioned vertically and a second vertically aligned surface 28 at a distance from the first surface 27. The first and second surfaces 27 and 28 of the one (upper) track member 17 are aligned substantially parallel when the one track member 17 is installed in the second track member 19.

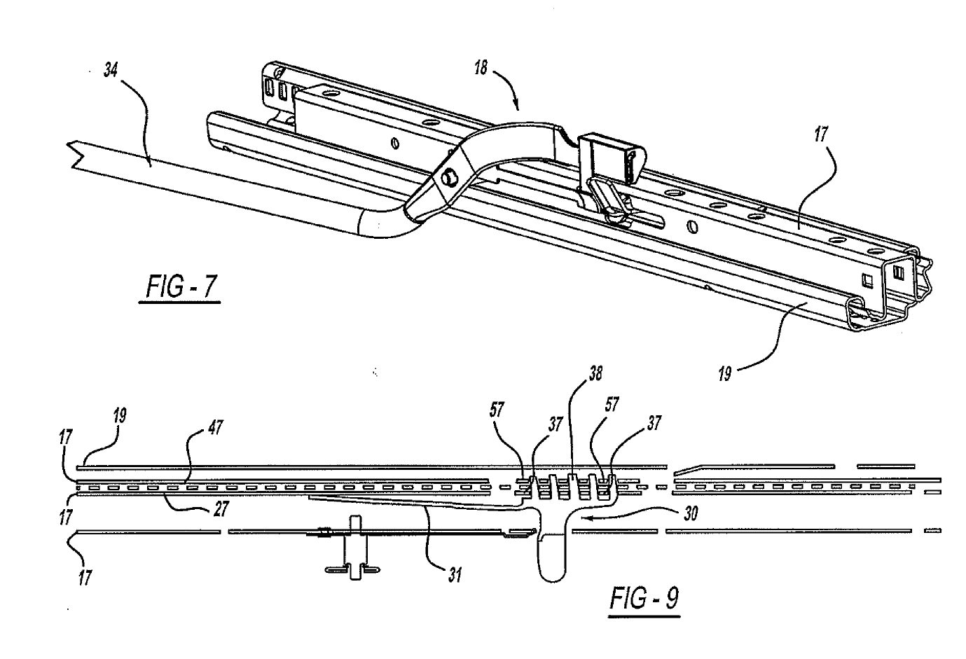

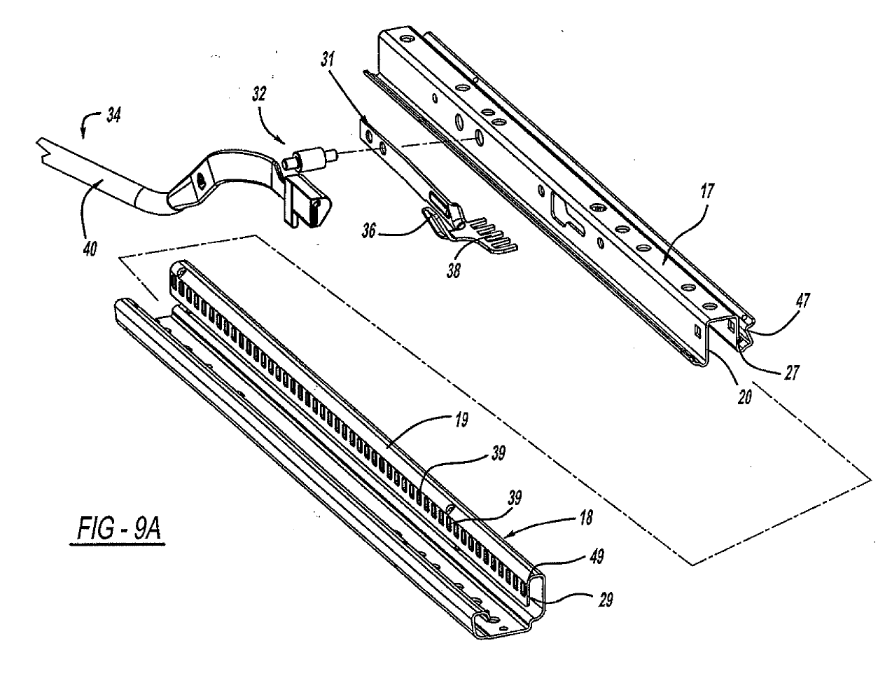

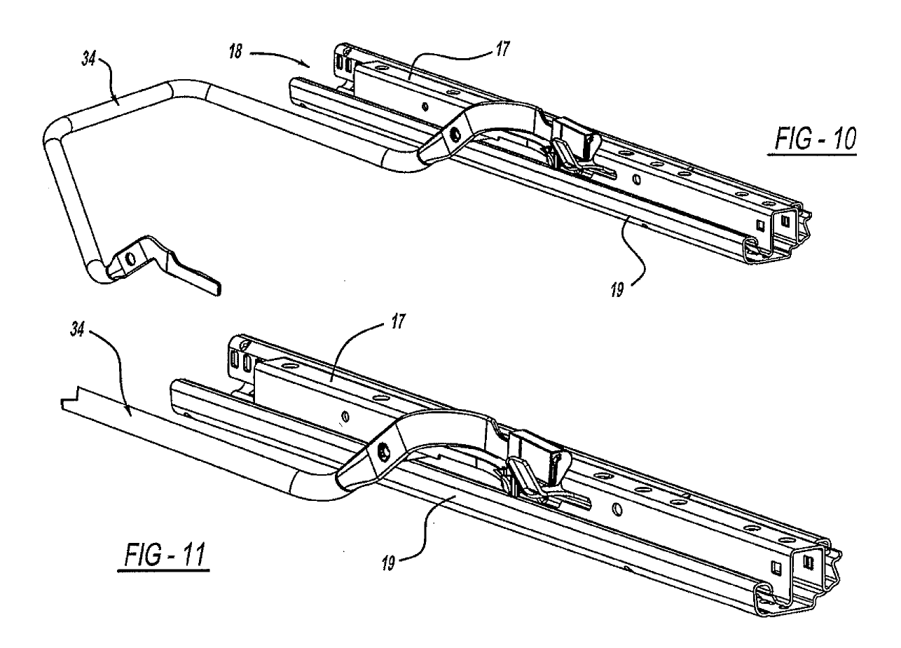

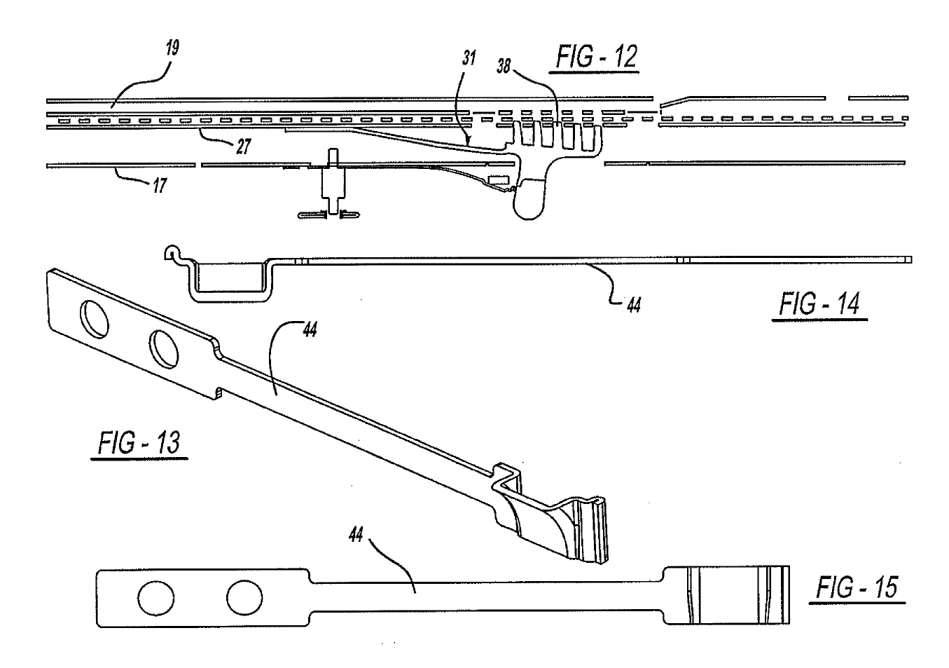

In the exemplary embodiment shown in FIGS. 3 through 17, the latch member 31 is attached to the first inside surface 27 of the upper track member 17 using holes located on the first side 27 of the first track member 17. As shown in FIG. 7, an X, Y, Z coordinate system is included and will be referenced in this application for purposes of describing the exemplary embodiments. It should be further noted that the X direction of the X, Y, Z coordinate system coincides (or is aligned) with the longitudinal direction of the track assembly 16 and the track members 17 and 19. The latch member 31 is a one-piece, metallic member that is preferably stamped and folded to have the shape as best shown in FIG. 6. It is possible to have the one-piece latch member 31 manufactured using any known or appropriate manufacturing operation. An actuator 34 is provided for actuating the latch member 31 via an extension portion 36 of the latch member 31 that extends beyond the track assembly 16. The extension portion 36 of the one-piece latch member 31 generally extends in a direction opposite the teeth 38 located at the one end of the one-piece latch member 31. The extension portion 36 of the one-piece latch member 31 also extends in a second direction offset from the one end of the one-piece latch member 31 at a predefined ramp angle for use in interacting with the actuator 34 for operating the one-piece latch member 31.

It is contemplated that the actuator 34 may have any known or appropriate design for actuating the latch mechanism 30. The actuator member 34 is disclosed as a bent tubular member 40 having a mostly U-shaped appearance (referred to as a towel bar in the vehicle seat technical area) and pivoted at connections of the legs of the U-shaped member 40 to the track member 17. The actuator 34 is preferably made from a metal material appropriate for such applications but may alternatively be made from any known or appropriate material capable of functioning in the particular application.

In the exemplary embodiments shown in FIGS. 6 through 7 the one-piece latch member 31 and the actuator 34 share a connection in the form of a pivot member 32 that is fastened to the track member 17. Further, in the one exemplary embodiment shown it is contemplated that the one piece latch member 31, the blocker plate 44 and the actuator 34 share a common connection in the form of a pivot member 32 that is fastened to the track member 17 and functions as a pivot for the actuator member 34.

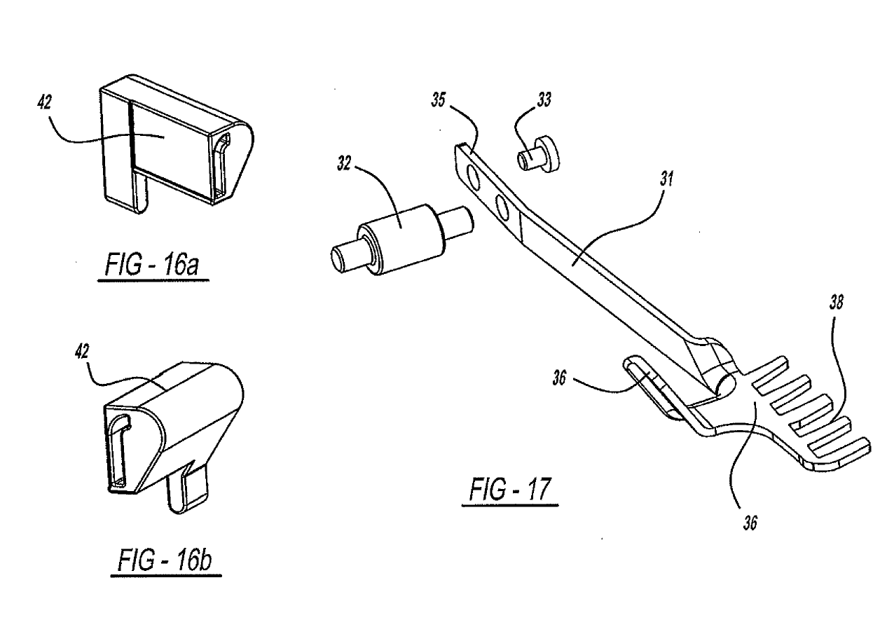

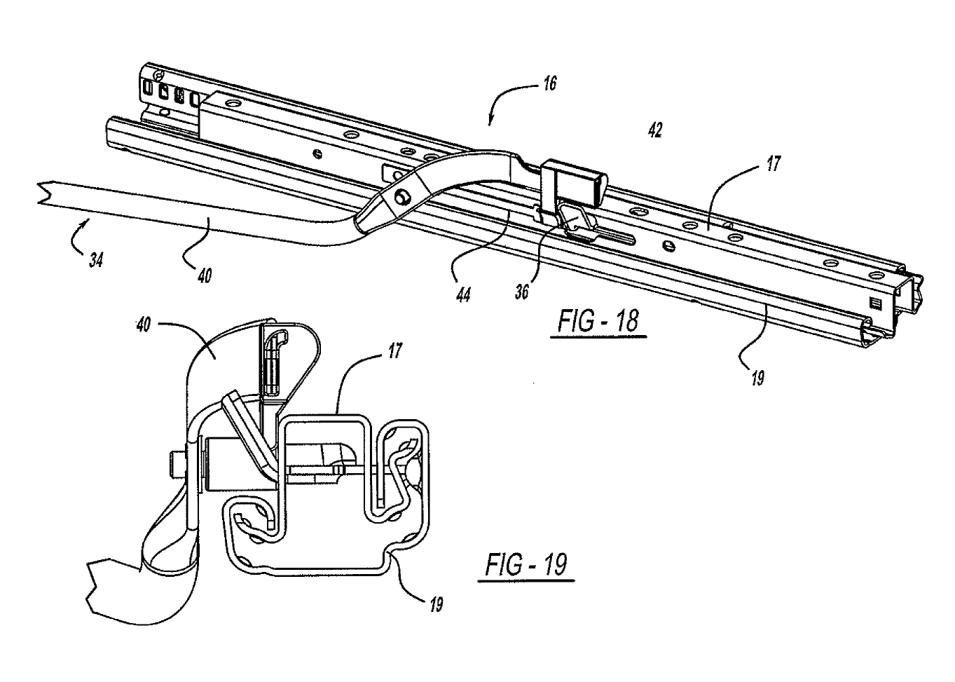

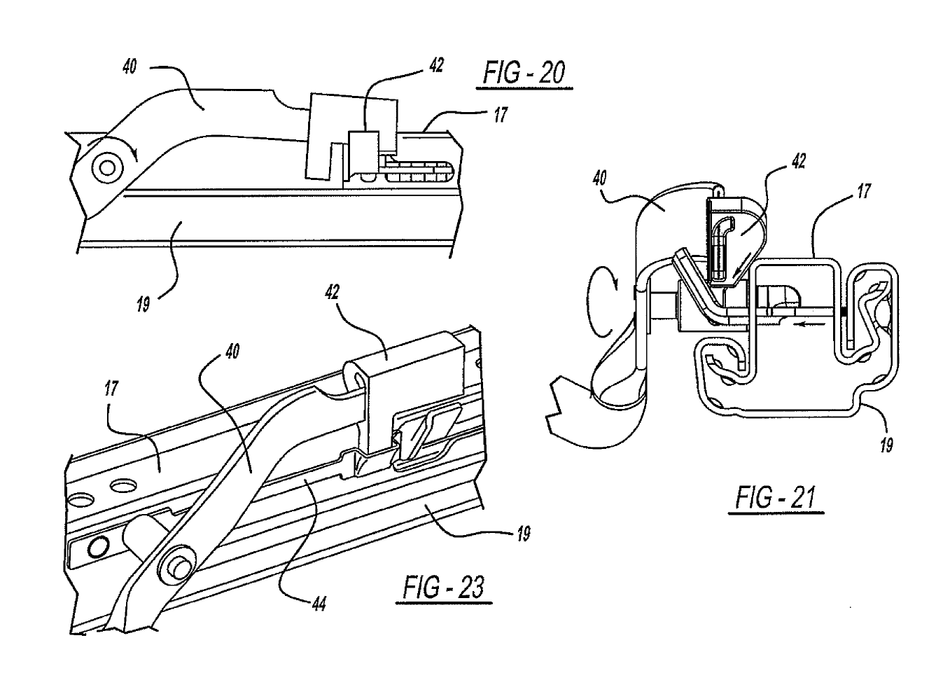

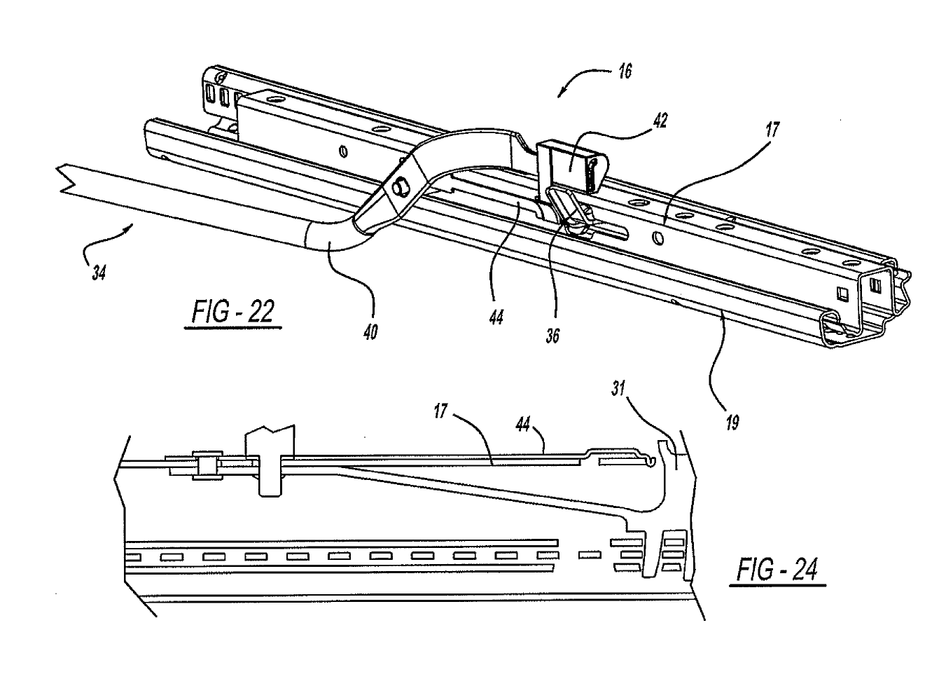

It is further contemplated that the end of the actuator member 40 that contacts each latch member 31 in each track member 17 and 19 includes an end member 42 such as those shown in FIG. 16. Each end member 42 is preferably made of a plastic material and has a substantially L-shaped appearance with one leg of the L connecting to the actuator member 34 and the other leg of the L for interacting with the latch member 31 and the one track member 17 as best shown in FIGS. 18 through 23. The one leg of the actuator's end members 42 includes a ramp portion or surface for contacting the outer surface of the upper track member 17 when the actuator 34 is pivoted to actuate (unlatch) the one-piece latch member 31, as best shown in FIGS. 18 through 23. As a user of the actuator 34 pivots it toward the unlatched position the ramp portion forces the ends of the actuator member 34 in board of the track members 17 and 19 and the other leg of the end members 42 then push on the extension portion 36 of the one-piece latch member 31 of the one piece latch 30 extending beyond the hole in the upper track member 17.

The one-piece latch member 31 is a relatively long and flat (thin) metal member and its relative flexibility will affect its performance such as when a load is applied to the vehicle seat assembly 10, such as during a vehicle impact. As best shown in FIG. 6, in this exemplary embodiment, the latch assembly 30 includes a blocker member attached to the exterior of the one track member 17 and aligned with the latch member 31.

The blocker member 44 is also a relatively thin plate-like member, preferably made of a single piece of material, that is connected to the same connection that functions as the pivot of the actuator 34 for the latch member 31. The blocker member 44 includes a first portion, preferably located at one end thereof and preferably distal the end of the blocker member 44 connected to the track member 17 that extends into the hole in the one track member 17. The hole in the one track member 17 is the same hole (or window or passage, etc.) from which the latch member 31 extends.

The first portion of the blocker member 44 extending into the hole on the one track member 17 functions to reduce the area of the hole around the portion of the latch member 31 extending through the hole. The first portion of the blocker member 44 functions to reduce the clearance between the edge of the hole and the proximal edge of the latch member 31. During an event (very rapid acceleration or deceleration) affecting the vehicle 5 such as occurs when the vehicle 5 is in an accident, a force will be directed through the vehicle 5 and into the vehicle seat 10. The force will necessarily pass through the seat track assembly 16 and ultimately the first and second track members 17 and 19 and the latch member 31 latching the first and second track members 17 and 19 in position. The force causes the first and second track members 17 and 19 to attempt to move with respect to each other and the latch member 31 (its teeth inserted in the holes in the first and second track members 17 and 19) functions to oppose the force attempting to make the first and second track members 17 and 19 move. If the force is sufficient, it may overcome the force of the latch member 31 forcing the teeth of the latch member 31 into the holes in the first and second tracks 17 and 19. If the latching force of the latch member 31 is exceeded, the latch member 31 may be deflected from the force direction due to the flexibility of the latch member 31. Accordingly, the portion of the blocker member 44 located in the hole opposes and limits the flexibility of the latch member 31 in a loading event such as those due to a vehicle impact.

As best shown in FIGS. 13 through 15, the blocker member 44 includes an extension portion located adjacent the one end extending into the hole in the track member. The extension portion of the blocker member 44 is a ramped portion that extends away from the one track member 17 more at the upper end of the extension portion than at the lower portion of the extension portion. The extension portion is designed to receive the one leg portion of the L-shaped end member of the latch member actuator 34. It is contemplated that the extension portion of the blocker member 44 will be engaged by one leg of the L-shaped end member of the towel bar actuator 34 when the other leg of the L-shaped member disengages the latch member 31 from the track members 17 and 19.

The blocker member 44 is disclosed as a one piece member preferably formed as a single piece stamped member such that the blocker member 44 flexes to be removed from the hole in the track member 17. The blocker member 44 is deactivated by the towel bar actuator 34 when it is flexed from the hole in the one track member 17 during actuation of the latch member 31 as best shown in FIGS. 18 through 21. It should be noted that while the blocker member 44 is disengaged simultaneously as the latch member 31 is disengaged, it is possible to sequentially first disengage the blocker member 44 and then unlatch the latch member 31. Further, it is contemplated that separate actuators may be used for operating the blocker member 44 and the latch member 31.

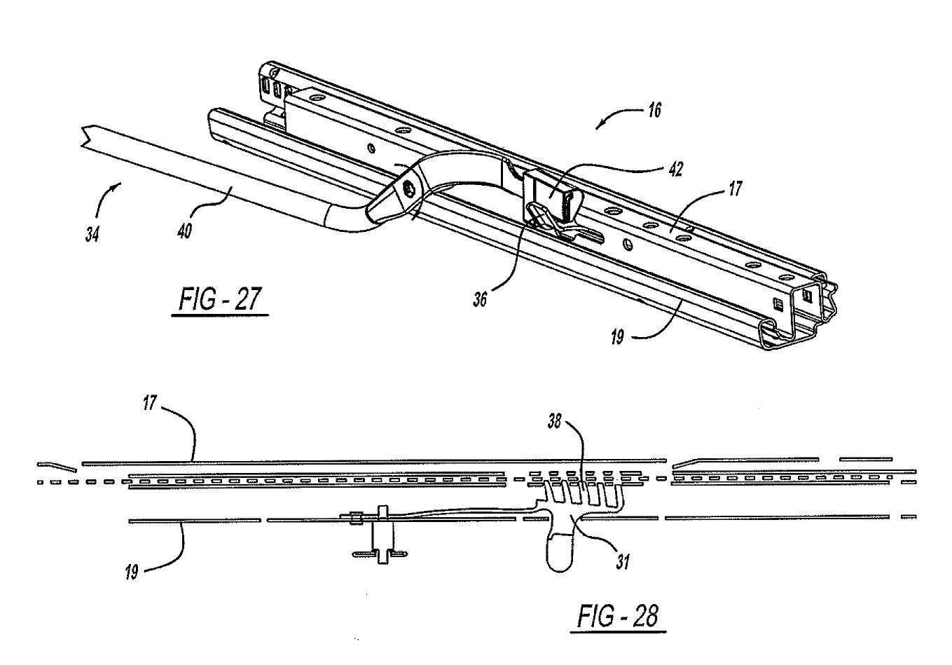

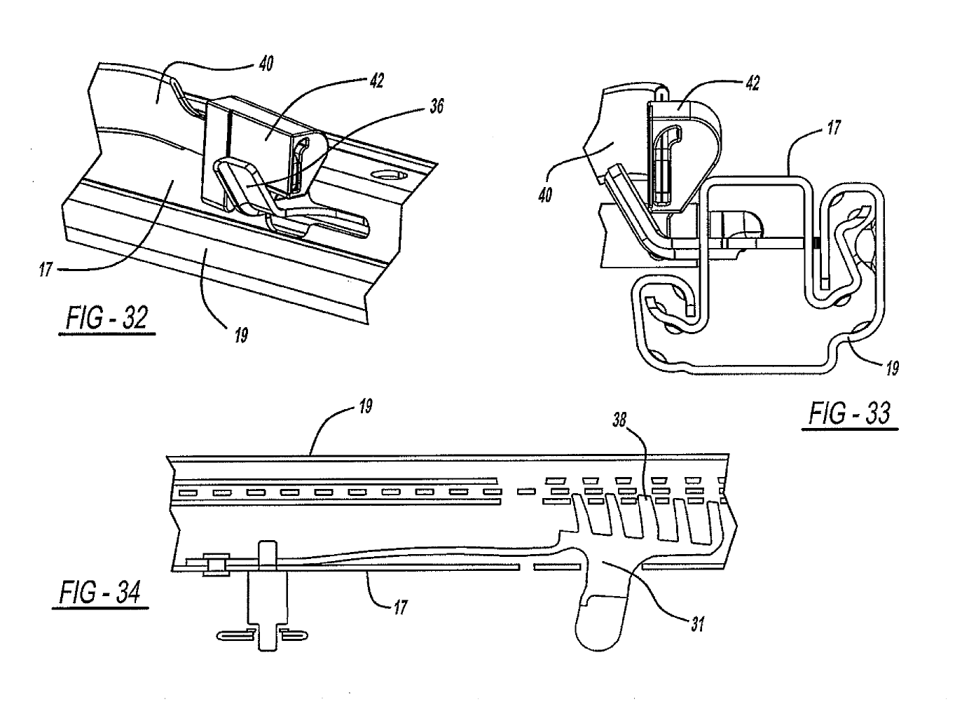

In an alternate exemplary embodiment, as best shown in FIGS. 25 through 36, it is contemplated that it is possible to achieve the equivalent function of the blacker member 44 in the latch member 31 of the exemplary embodiment of FIGS. 18 through 24 without including the blocker member 44 in the latch member 31 or track assembly 16. It is contemplated that by optimizing the design of the latch member 31 and the hole in the one track member 17 through which the latch member 31 extends, it is possible to have a one-piece latch member 31 connected to and pivoted at the opposite side of the track member 17 that does not disengage in a loading event.

The latch member 31 is attached to the first (opposite) side wall of the one (upper) 27 track member 17 and the latching holes 57 for the latch member 31 are located on the second of the side walls of the one (upper) track member 17. With this arrangement, it is contemplated that the latch member's end portion 36 and teeth 38 have been angularly adjusted to account for the changed location of attachment of the one piece latch member 31 and thereby a different location about which the latch member 31 will pivot as best shown in FIGS. 25 through 36.

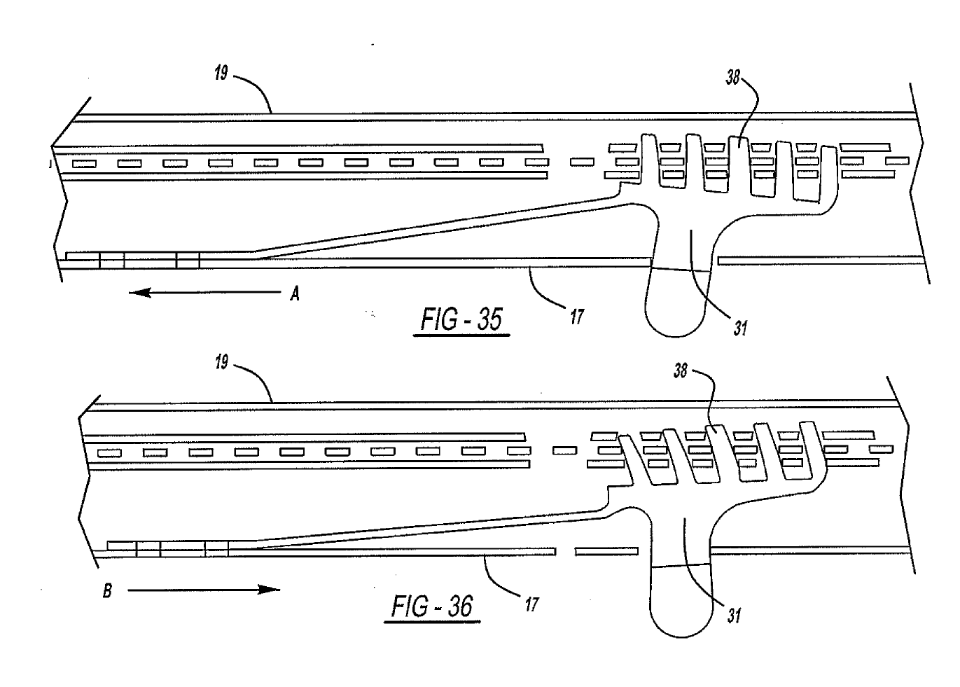

Reference now to FIGS. 35 and 36, during a loading event the latch member 31 will remain latched by the extension portion 36 of the latch member 31 contacting the edge of the hole on the (first or second) side of the track member 17. Since the track member also functions to keep the latch member 31 engaged during the loading event, there is a reduced sensitivity to dimensional variations of the width and height of the holes on the second side 47 of the upper track member 17 and the height of the holes on the second side of the lower track member 19.

Accordingly, the latch member 31 will remain latched during a loading event such that is sufficient for use in vehicle seat applications and the associated operating and performance requirements.

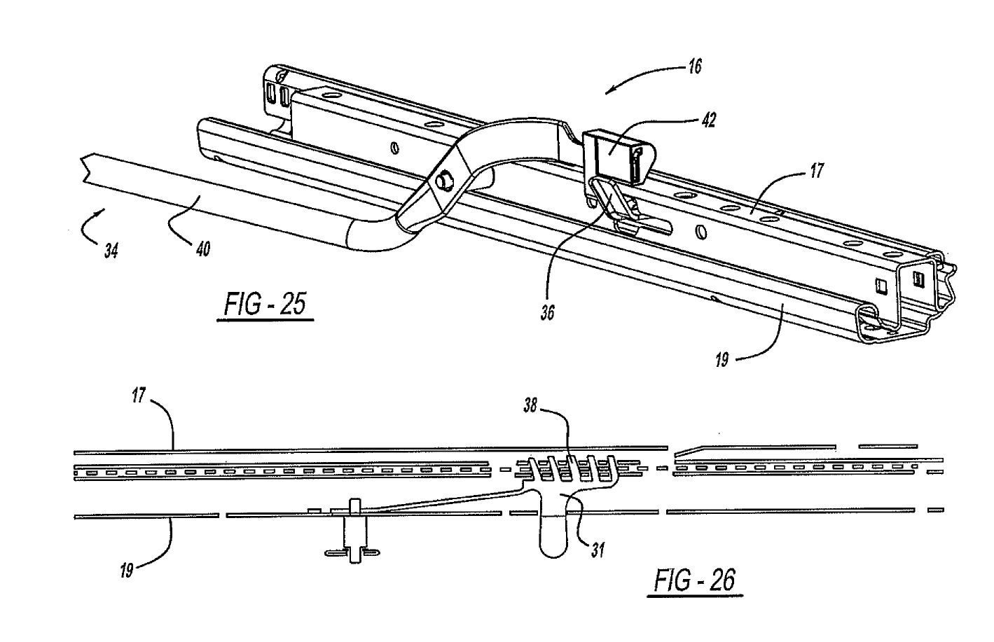

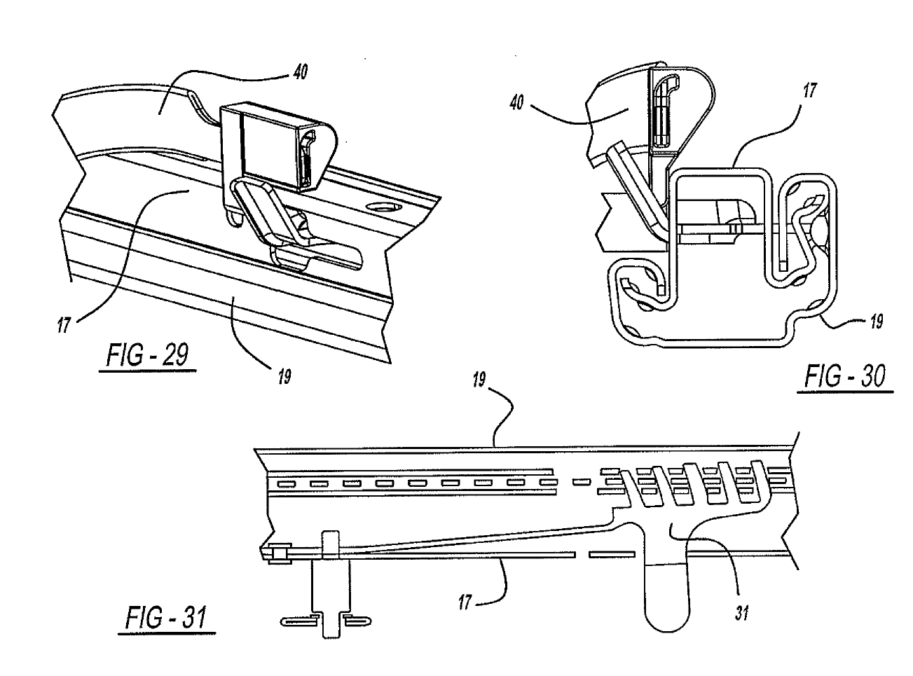

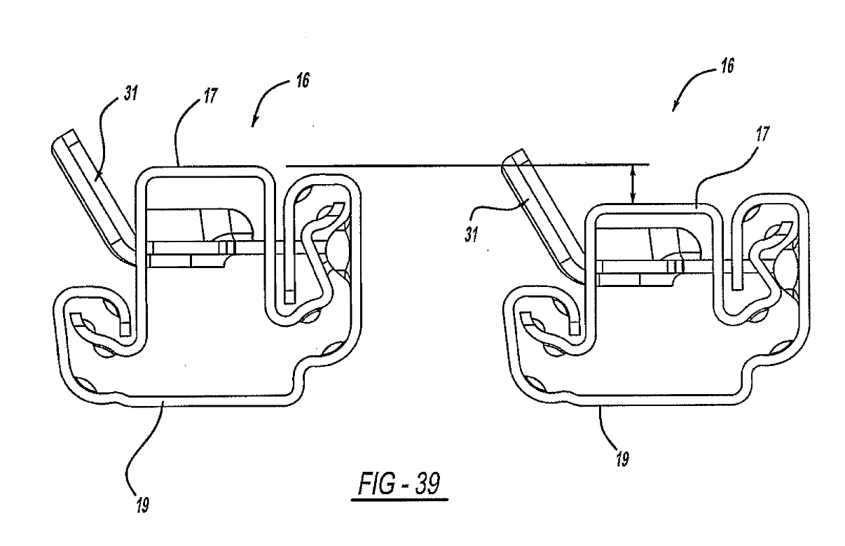

Referring now in particular to FIGS. 26 and 29, it is noted that the relatively thin and flat one-piece latch member 31 disclosed in the exemplary embodiments herein is designed to operate non-linearly in the X-Y plane of the vehicle seat track member 19 as compared to traditional latch members which operate non-linearly in the X-Z and Y-Z planes and linearly in the X-Y and X-Z planes of a vehicle seat track member 19. The one-piece latch member 31 operating non-linearly in the X-Y plane requires less vertical height for effective operation than a traditional latch member 31, as best illustrated in side-by-side comparison shown in FIG. 39 wherein the examples are provided showing the one-piece latch member 31 in a traditional track section and a modified track section showing the potential available track section height savings. The one-piece latch member 31 disclosed makes it possible to reduce the heights of the track members from that which is required with the traditional latch members. A reduction in the heights of the track members allows less material to be used in the track members which reduces the mass and cost thereof.

In this alternate exemplary embodiment, the hole in the track member 17 through which the extension portion 36 of the latch member 31 passes is optimized for purposes of maintaining engagement of the latch member 31 during a loading condition. In the embodiment shown, the flexibility of the latch member 31 during the loading condition does not allow unlatching of the latch member 31. A force will cause movement of the latch member 31. However, the one-piece latch member 31 is installed and arranged in the one track member 17 such that when loaded, the latch member 31 will engage the one track member 17 and generate a responsive force to overcome the latch force of the latch member 31. Accordingly, the latch member 31 will remain latched during a loading event such that is sufficient for use in vehicle seat applications and the associated operating and performance requirements.

With particular reference to FIG. 35, a load is applied to the track assembly 16 in the direction of the arrow A applying a shear force to the teeth 38 of the latch member 31 causing the end of the latch member 31 to rotate. When the end of the latch member 31 rotates, the one (first) side of the extension member 36 of the one-piece latch 30, extending through the hole in the one track member 17, engages the edge of the optimized hole in the one track member 17 to stop the movement of the one end of the latch member 31 thereby keeping the latch member 31 latched. Similarly, with respect to FIG. 36, a load is applied in a direction of the arrow B causing a shear force on the teeth 38 of the latch member 31 causing the end of the latch member 31 to rotate in the other direction and causing the other (second) side of the extension member of the one-piece latch, extending through the hole in the one track member 17, to engage the edge of the optimized hole in the one track member 17 to stop the movement of the one end of the latch member 31 thereby keeping the latch member 31 latched.

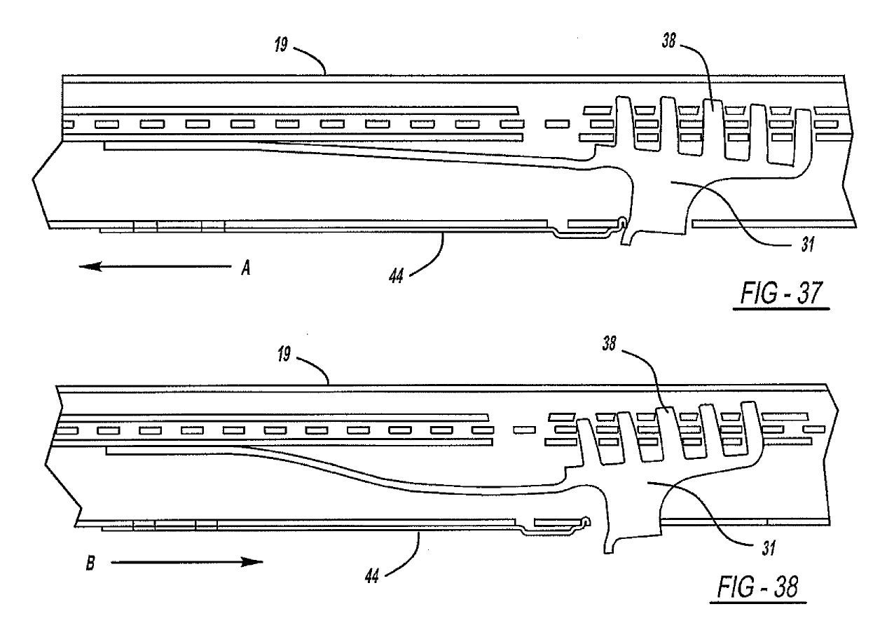

Referring now to FIGS. 37 and 38, loading of the one-piece latch member 31 embodiment including the blocker member 44 is shown. In this exemplary embodiment, and with the latch member 31 in the latched (unactuated) position, a force is applied to the track assembly 16 in the direction of arrow A in FIG. 37 and in the direction of arrow B in FIG. 38. In both instances, the end of the latch member 31 having the teeth 38 latching the track members 17 and 19 is rotated (clockwise in FIG. 37 and counter-clockwise in FIG. 38). In both instances the movement or rotation of the extension member 36 is limited to prevent disengagement of the latch member 31 during the loading event.

In FIG. 37 the extension member of the latch member 31 extending beyond the one track member 17 engages the end of the blocker member 44 in the hole in the one track member 17 when the one end of the latch member 31 is rotated clockwise by the force applied. In FIG. 38 the extension member 36 of the latch member 31 extending beyond the one track member 17 contacts or engages the edge of the hole in the one track member 17 when the one end of the latch member 31 is rotated counter-clockwise by the force applied.

Comparing the performance of the one-piece latch member 31 of the embodiment of FIGS. 35 and 36 (i.e., without a blocker member) with the performance of the one-piece latch member 31 of the embodiment of FIGS. 37 and 38 (i.e., with a blocker member), it is contemplated that regardless of the location of the attachment of the latch member 31, the one-piece latch member 31 is designed to operate as a vehicle seat track latch to maintain its ability to remain latched during a loading event such that it is appropriate for use in a vehicle seat track assembly 16 application.

Referring again to all of the FIGURES, including the figures showing the normal operation of the one-piece latch member 31 in the exemplary embodiments of FIGS. 1 through 39, it should be noted that the one-piece latch member 31 is designed to travel along at least two different, non-linear paths or arcs. A first path of travel for the one-piece latch member 31 relates to when an operator (such as an occupant) unlatches the latch member 31 through actuation of the track actuator. The second path of travel for the one-piece latch member 31 relates to when the track assembly 16 has a force applied to it such as during a loading event. The first and second paths are sufficiently different due to the different directions of the forces that are applied to the latch member 31 during normal latch actuation (i.e., unlatching) and during force loading on the track. The latch member 31 and track member have been designed such that the latch 31 is always free to travel along the first path, while the motion of the latch 31 along the second path is blocked, preventing disengagement of the latch member 31 during normal operating conditions (normal load forces) and during a loading event (such as forces applied to the vehicle seat track assembly 16 during a vehicle 5 impact).

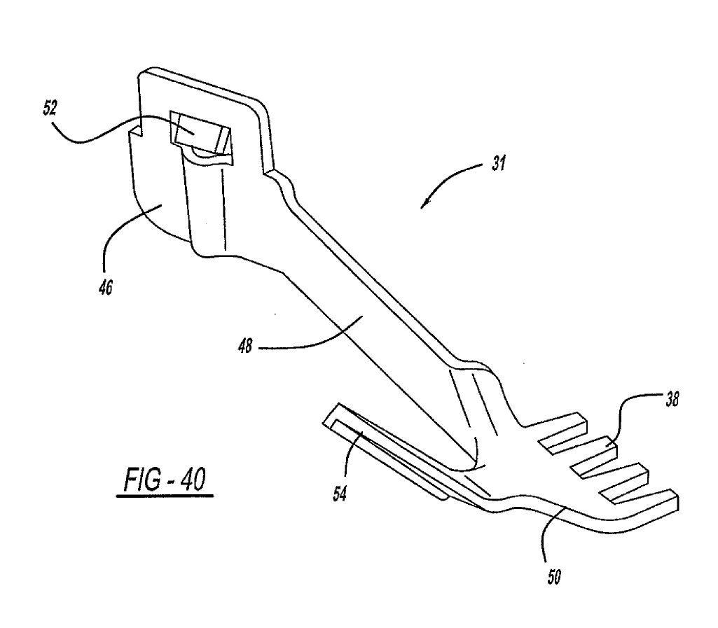

Referring to FIG. 40, the latch member 31 is shown according to an exemplary embodiment. In the exemplary embodiment shown, the latch member 31 is a unitary, stamped and formed sheet metal material part that includes a pivot base portion 46, a pivot arm 48 that extends outward from the pivot base portion 46, and an engagement portion 50 that is formed as a portion of the arm opposite of the pivot base portion 46. The pivot base portion 46 is coupled to the upper track 17 and may alternatively be coupled to another structure so as to still be movable with the upper track 17. According to the shown embodiment, the pivot base portion 46 includes a flap or tab 52 that is angled outward from the pivot base portion 46. The tab 52 is inserted into a slot or opening in the upper track 17 to couple the latch 31 to the upper track 17 and provide a locating function. The tab 52 is particularly advantageous as it provides a mechanism to couple the latch 31 to the upper track 17 without the need of an additional fastener such as a bolt. Further, the tab 52 may be deformed, parent metal staked or otherwise mechanically deformed to provide a secure connection between the latch 31 and the upper track 17. Further, alternative connections for securing the latch 31 may include riveting 33, fasteners, parent metal staking and other appropriate methods. Also, the latch 31 may be connected to the upper track 17 as part of the assembly of the fulcrum or pivot rod to the upper track 17.

The engagement portion 50 in the embodiment shown includes a multitude of regularly spaced extensions or teeth 38 that are configured to extend through openings in the lower track 19 and corresponding openings in the upper track 17 to prevent relative movement there between. According to one exemplary embodiment, the engagement portion 50 may have more or fewer teeth 38 and have alternative configurations. The engagement portion 50 further includes a wing or projection 54 that extends outward opposite of the teeth 38 and is angled upward relative to the teeth 38. The projection 54 extends outward through an opening in the upper track 17. According to various exemplary embodiments, the track system 16 may include a latch 31 in one or in both track assemblies 16.

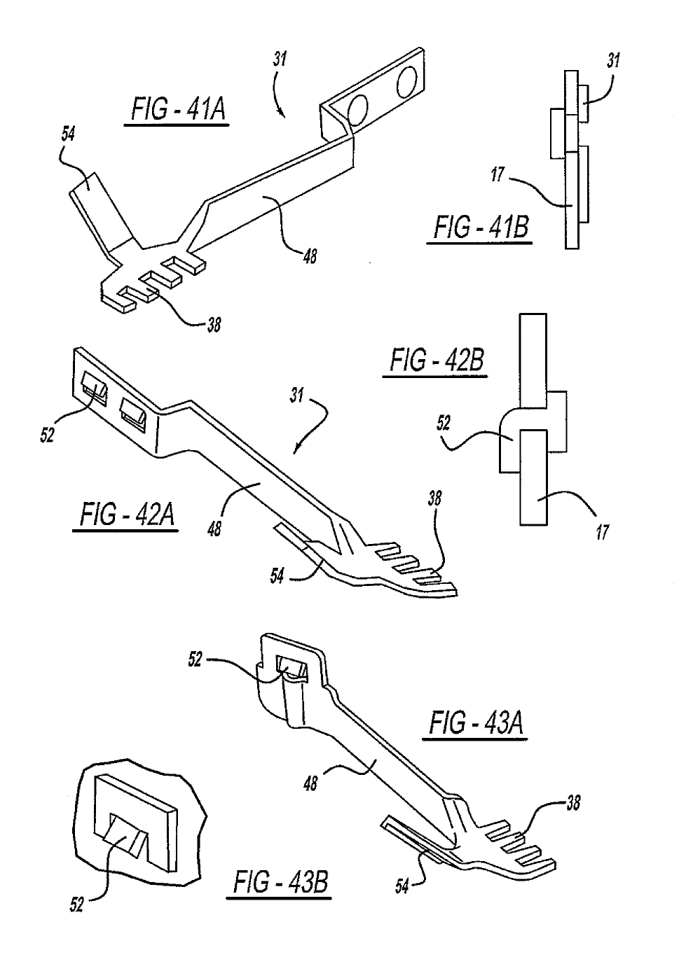

The latch mechanism 30 may be pivotally coupled to the upper track 17 or another member movable with the upper track 17 with a variety of mechanisms. As shown in FIGS. 41A and 41B, the latch member 31 may be coupled to the track 17 with one or more integrally formed rivets 33. Coupling the latch member 31 to the track with integrally formed rivets 33 does not require any additional components and may be done with a single attachment operation.

As shown in FIGS. 42A and 42B, the latch mechanism 30 may include one or more integrally formed tabs that are received by corresponding openings in a sidewall of the upper track 17. Coupling the latch member 31 to the track with integrally formed tabs 52 does not require any additional components and may be done with a single attachment operation.

As shown in FIGS. 43A and 43B and described in more detail earlier in the application, the latch mechanism 30 may be coupled to the track 17 with a snap fit using an integrally formed tab 52. Coupling the latch mechanism 30 to the track 17 with a snap fit does not require any additional components and may be done with a single attachment operation that does not require any special tools such as a press.

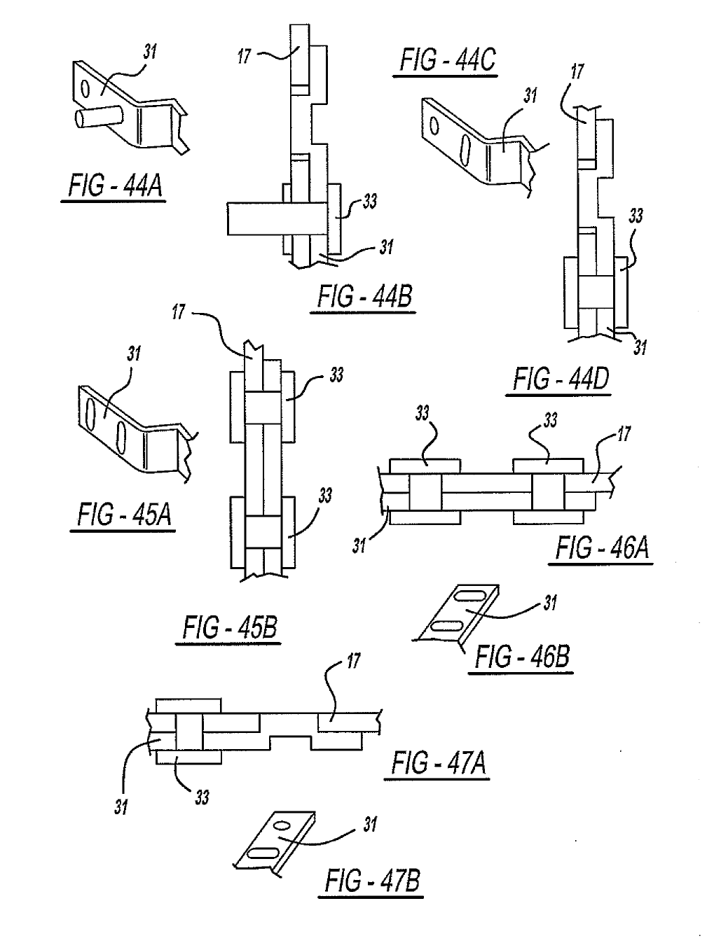

As shown in FIGS. 44A through 44D, the latch 30 may be coupled to a side wall of the track 17 with one coupling member such as a rivet 33 and a semi-pierced hole. Coupling the latch mechanism 30 to the track 17 with a rivet 33 and a semi-pierced hole requires only an additional component. A rivet 33 and a semi-pierced hole provide a known reliable joint and provides a pivot for the actuator.

As shown in FIGS. 45A and 45B, the latch mechanism 30 may be coupled to a side wall of the track 17 with two rivets 33. Coupling the latch mechanism 30 to the track 17 with two rivets 33 requires only two additional components. Two rivets 33 provide a known reliable joint and provides a pivot for the actuator.

As shown in FIGS. 46A and 46B, the latch mechanism 30 may be coupled to the top of the track 17 with two rivets 33. Coupling the latch mechanism 30 to the track with two rivets 33 requires only two additional components. Two rivets 33 provide a known reliable joint and provides a pivot for the actuator.

As shown in FIGS. 47A and 47B, the latch mechanism 30 may be coupled to the track 17 with one coupling member such as a rivet 33 and a semi-pierced hole. Coupling the latch mechanism 30 to the track 17 with a rivet 33 and a semi-pierced hole requires only an additional component. A rivet 33 and a semi-pierced hole provide a known reliable joint and provides a pivot for the actuator.

The construction and arrangement of the elements of the latch mechanism as shown in the illustrated and other exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, while the latch mechanism 30 described herein is shown as being used in combination with a vehicle seat track assembly 16, such a latch mechanism 30 may also be suitable for use with track assemblies used in other applications. Further, elements shown as integrally formed may be constructed of multiple parts or elements, the position of elements may be reversed or otherwise varied, and the nature or number of discrete elements or positions may be altered or varied. It should be noted that the elements and/or assemblies of the latch mechanism 30 may be constructed from any of a wide variety of materials that provide sufficient strength or durability in any of a wide variety of colors, combinations and suitable materials. Other substitutions, modifications, changes and omissions may be made in the design, operating conditions and arrangement of the preferred and other exemplary embodiments without departing from the scope of the present disclosure which is limited solely by the claims.

What is claimed is:

1. A latch for latching a first track member and a second track member wherein the second track member is movable relative to the first track member in at least one degree of freedom, the latch comprising:
a. a latch body having a first portion for attaching the latch to the second track member and a second portion extending from the first portion;
b. a third portion connected to the second portion and having an engagement portion for transferring loads between the second track member and the first track member to prevent relative movement there between;
c. a fourth portion connected to the second and third portions, the fourth portion for connecting to an actuator for actuating the latch, the fourth portion extending beyond the second member; and
d. wherein the movement of the engagement portion is limited to maintain the load transfer between the first and second track members when a load is applied to one of the first and second track members.

2. The latch of claim 1 wherein the first and second members are first and second track sections of a vehicle seat track assembly; and the engagement portion comprises a plurality of teeth for extending into openings in the first and second track members.

3. The latch of claim 1 wherein the latch is comprised of a single piece of material.

4. The latch of claim 3 wherein first and second track members define a space and the latch is at least partially located in the space; further wherein the first portion of the latch includes a fastener for coupling the latch to the second track member; further wherein the second portion is a latch body, and wherein the fourth portion is an actuator member having at least a portion thereof extending through a hole in the second track member and the latch contacts the hole in the second track member to limit the engagement portion from disengaging when a load is applied to the second track member.

5. The latch of claim 1 wherein first and second track members define a space and the latch is at least partially located in the space; further wherein the first portion of the latch includes a structure for fastening the latch to the second track member, the second portion is a latch body, the engagement portion includes a plurality of teeth for extending into holes in the first and second track members and the fourth portion is an actuator portion having at least a portion thereof for extending beyond the second track member; wherein the engagement portion is movable non-linearly in a direction in a plane perpendicular to a longitudinal direction of the first and second track members for latching the first and second track members; and wherein the latch contacts the second track member to limit movement of the third portion of the latch to maintain the load transfer between the first and second track members.

6. A latch for restricting the relative movement of a first member and a second member wherein the second member is movable relative to the first member in at least one degree of freedom, the latch for being coupled to one of the first and second members, the latch comprising:
a. a load transferring portion for transferring the load between the first member and the second member to prevent movement of the second member with respect to the first member;
b. a release portion for moving the latch in a direction to prevent the load from being transferred between the first and second members; and
c. wherein the movement of the load transferring portion is limited to maintain the load transfer between the first and second members when a load is applied to one of the first and second members.

7. The latch of claim 6 wherein the latch comprises a blocker member for limiting the movement of the load transferring portion when a load is applied to one of the first and second members.

8. The latch of claim 6 further comprising a blocker member coupled to one of the first and second members separate from the latch.

9. The latch of claim 6 further comprising a blocker member coupled to one of the first and second members wherein the latch is movable along a first path of travel when the latch is actuated by an operator to unlatch the latch and is movable along a second path of travel for the when a load is applied to one of the first and second members.

10. A track assembly for a vehicle seat for adjusting the position of the vehicle seat, the track assembly comprising:
a. a first pair of track rail members for being located toward a first side of the vehicle seat and a second pair of track rail members for being located toward a second side of the vehicle seat, each pair of track rail members having a first track member and a second track member;
b. a latch for latching the first track member and the second track member wherein the second track member is movable relative to the first track member in at least one degree of freedom, the latch comprising:
a. a latch body having a first portion for attaching the latch to the second track member and a second portion extending from the first portion;
b. a third portion connected to the second portion and having an engagement portion for transferring loads between the first and second track members to prevent relative movement there between;
c. a fourth portion connected to the second and third portions, the fourth portion for engaging an actuator for actuating the latch, the fourth portion extending beyond the second member; and
d. wherein the movement of the engagement portion is limited to maintain the load transfer between the first and second track members when a load is applied to one of the first and second track members;
c. an actuator for moving the latch between latched and unlatched positions, the actuator having a first portion aligned with the first pair of track members, the first portion for engaging the fourth portion of the latch, a second portion aligned with the second pair of track members and a center portion for use by an operator.

11. The track assembly of claim 10 further comprising a pivot member for forming a connection among the first portion of the latch, the second track member and the first portion of the actuator wherein the first portion of the latch is fixedly connected to the second track member and the actuator is pivotally connected to the second track member.

12. The track assembly of claim 10 further comprising a second latch in the second pair of track rail members, the second latch comprising.

13. The track assembly of claim 10 further comprising a blocker member having a first portion connected to the second track member, a body portion extending the from the first portion and an end portion extending at least partially into a hole in the second track member and aligned proximal the fourth portion of the latch to engage the fourth portion when a load is applied to the second track member.

14. The track assembly of claim 13 wherein the actuator engages the blocker to move the blocker from the hole in the second track member.

15. The track assembly of claim 13 wherein the actuator engages the blocker to move the end of the blocker from the hole in the second track member when the actuator engages the fourth portion to move the latch from the latched position.

16. The track assembly of claim 15 wherein the actuator moves the blocker simultaneously while the actuator is moved toward the unlatched position.

17. A latch for restricting the relative movement of a first track member and a second track member of a track assembly for use in a vehicle seat, the first and second track members extending longitudinally aligned with a first direction and including a plane extending horizontally to the oriented direction of the first and second track members and including the first direction, the second member being movable relative to the first member in the first direction, the latch comprising:
a. a connection portion for connecting the latch to the second track member;
b. a body portion extending from the connection portion; and
c. a latch portion connected to the body portion, the connection portion and the body portion for biasing the latch portion in a second direction in the horizontal plane and not aligned with the first direction, the latch portion for latching the first and second track members to transfer a load applied to one of the first and second track members to the other of the first and second track members, wherein the latch portion is movable in the horizontal plane to latch the first and second track members.

18. The latch of claim 17 wherein the latch portion is movable in a direction substantially opposite the second direction to unlatch the first and second track members.

19. The latch of claim 17 wherein the latch portion moves non-linearly between the latched position and the unlatched position.

20. The latch of claim 19 wherein the latch portion moves along a curvilinear path between the latched position and the unlatched position.

21. The latch of claim 20 wherein the curvilinear path has a non-constant radius as the latch portion moves between the latched position and the unlatched position.

22. A track assembly having first and second track members movable relative to each other for adjusting the position of a vehicle seat in a vehicle, a latch for selectively coupling the first and second track members and an actuator for selectively operating the latch, the track assembly comprising a connector having a first portion for pivotally coupling the actuator to the track assembly and a second portion for coupling the latch to one of the first and second track members.

23. The track assembly of claim 22 wherein the actuator comprises an elongated member having a first portion for connection with the connector and a second portion for use by an occupant for moving the actuator and operating the latch.

24. The track assembly of claim 23 wherein the elongated member has a generally u-shaped construction having two leg portions, each leg portion being pivotally connected to the track assembly.

25. A latch for restricting the relative movement of a first track member and a second track member of a track assembly for use in a vehicle seat, the first and second track members extending longitudinally aligned with a first direction and including a plane extending horizontally to the oriented direction of the first and second track members and including the first direction, the second track member being movable relative to the first track member in the first direction, the latch having a one-piece construction and comprising a latch portion for latching the first and second track members to transfer a load applied to one of the first and second track members to the other of the first and second track members and a biasing portion for biasing the latch portion toward the latch position, wherein the latch portion is movable non-linearly in a second direction in the horizontal plane and not aligned with the first direction for latching the first and second track members.
